(19) United States
(12) Patent Application Publication
(10) Pub. No.: US 2012/0306114 A1
(43) Pub. Date: Dec. 6, 2012

(54) PROCESS FOR PREPARING BIOCOMPATIBLE FREE-STANDING NANOFILMS OF CONDUCTIVE POLYMERS THROUGH A SUPPORT LAYER

(76) Inventors: Francesco GRECO, Massa e Cozzile (Pistoia) (IT); Virgilio MATTOLI, Pisa (IT); Paolo DARIO, Livorno (IT); Arianna MENCIASSI, Pontedera (Pisa) (IT); Alessandra ZUCCA, Genoni (Oristano) (IT)

(21) Appl. No.: 13/528,798

(22) Filed: Jun. 20, 2012

Related U.S. Application Data
(63) Continuation of application No. PCT/IB2011/055288, filed on Nov. 24, 2011.
(60) Provisional application No. 61/499,031, filed on Jun. 20, 2011.

(30) Foreign Application Priority Data
Nov. 24, 2010 (IT) FI2010A000231

(51) Int. Cl. B29C 41/42; B32B 27/08

(52) U.S. Cl. 264/104; 428/419

(57) ABSTRACT

A process for the preparation of nanofilms of conductive polymers is described. The process comprises forming support layers comprised of various polymers and free-standing nanofilms can be obtained thereby. The nanofilms obtained by the process can have characteristics such as strength, flexibility, ability to adhere to different substrates, and biocompatibility, which can make them suitable for numerous different technological applications, and in particular applications in the biomedical field.

### CROSS-REFERENCE TO RELATED APPLICATIONS

The present application claims priority to U.S. Provisional Patent Application Ser. No. 61/499,031 filed on Jun. 20, 2011 and is a continuation of International Application No. PCT/IB2011/055288 filed on Nov. 24, 2011 and published on May 31, 2012 as WO 2012/070016, which in turn claims priority to U.S. Provisional Patent Application Ser. No. 61/499,031 filed on Jun. 20, 2011 and to Italian Patent Application Serial No. FI2012A000231 filed on Nov. 24, 2010, the disclosure of each of which is herein incorporated by reference in its entirety.

### FIELD

The present disclosure relates to conductive polymers and in particular to a process for preparing nanofilms of conductive polymers.

### BACKGROUND

Conductive polymers, and their related properties and uses have been the subject of a very large number of studies.

However manipulation of conductive polymers in order to obtain thin conductive films and their dispersion and/or solubilisation can be challenging, in particular when performed in connection to the achievement of desired properties.

### SUMMARY

The present disclosure relates to a process for the preparation of biocompatible, free-standing nanofilms of conductive polymers which in some embodiments, can have characteristics of flexibility, strength, ability to adhere to different substrates, and/or biocompatibility.

According to a first aspect of the disclosure, a method for preparing biocompatible, free-standing nanofilms of conductive polymers is described. The method comprises sequentially depositing a layer of a first polymer and a layer of a conductive polymer on a support adapted for growth of a plurality of polymer layers, wherein the depositing of the layer of the conductive polymer comprises performing a spin-coating, to obtain a film comprising the layer of the first polymer and the layer of the conductive polymer on the support; thermally treating the film; depositing on the conductive polymer of the thermally treated film a layer of a second polymer such that the layer of the conductive polymer adheres to the layer of a second polymer, the layer of the second polymer being soluble in water; peeling off the layer of the conductive polymer together with the layer of the second polymer, from the layer of the first polymer on the support to obtain a peeled off layer of the conductive polymer on the layer of the second polymer; releasing the layer of the conductive polymer as a free-standing nanofilm, the releasing comprising immersing the peeled off layer of the conductive polymer on the layer of a second polymer and dissolving the layer of the second polymer in water.

According to a second aspect of the disclosure, an intermediate for a preparation of biocompatible, free-standing nanofilms of a conductive polymer is described. The intermediate comprises a layer of a conductive polymer on a layer of a second polymer and is obtainable by a method comprising: sequentially depositing a layer of a first polymer and a layer of a conductive polymer on a support adapted for growth of a plurality of polymer layers, wherein the depositing of the layer of the conductive polymer comprises performing a spin-coating, to obtain a film comprising the layer of the first polymer and the layer of the conductive polymer on the support; thermally treating the film; depositing a layer of a second polymer such that the layer of the conductive polymer adheres to the layer of a second polymer, the layer of the second polymer being soluble in water; and peeling off of the layer of the conductive polymer on the layer of the second polymer, from the layer of the first polymer on the support.

The intermediates, compositions, methods and systems herein described can be used in connection with applications wherein nanofilms of conductive polymers are desired. Exemplary applications comprise biomedical, and in particular for use as a support for seeding and proliferation of cells and additional applications associated to the use of nanofilms of conductive materials, and in particular to the use of biocompatible, free-standing nanofilms of conductive materials which are identifiable by a skilled person.

The details of one or more embodiments of the disclosure are set forth in the accompanying drawings and the description below. Other features, objects, and advantages will be apparent from the description and drawings, and from the claims.

### BRIEF DESCRIPTIONS OF THE DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a schematic representation of an intermediate film according to the disclosure, before dissolving the sacrificial layer of cellulose acetate.

FIG. 2 shows the progression of the surface resistivity of the PEDOT/PSS nanofilms obtained as described in Examples 1 to 4, as a function of the rotation speed applied in the step of deposition of the conductive layer of PEDOT/PSS. The values indicated with -∘- refer to the data obtained using the commercial product CLEVIOS™ PAG as precursor of the layer of PEDOT/PSS, whereas the values indicated with -- refer to the data obtained using the CLEVIOS™ PH1000 product.

FIG. 3 shows the progression of the values of surface resistance detected as a function of the rotation speed, for both the two series of films obtained from the two different commercial precursors of the layer of PEDOT/PSS, again supported on Si/PDMS. The values indicated with -∘- refer to the data obtained using the commercial product CLEVIOS™ PAG, whereas the values indicated with -- refer to the data obtained using the CLEVIOS™ PH1000 product.

FIG. 4 shows the progression of the values of surface resistance detected for three different series of nanofilms all prepared from CLEVIOS™ PH1000, as a function of the different rotation speeds applied. The values indicated with -- refer to the data obtained using the film of PEDOT/PSS again supported on Si/PDMS, the values indicated with -▪- refer to the free-standing films of PEDOT/PSS transferred on glass, whereas the values indicated with -□- refer to the same films transferred on glass but also subjected to thermal treatment at a temperature equal to 170° C. for 1 hour.

FIG. 5 shows a histogram that compares the values of conductivity detected for four different types of PEDOT/PSS nanofilms:

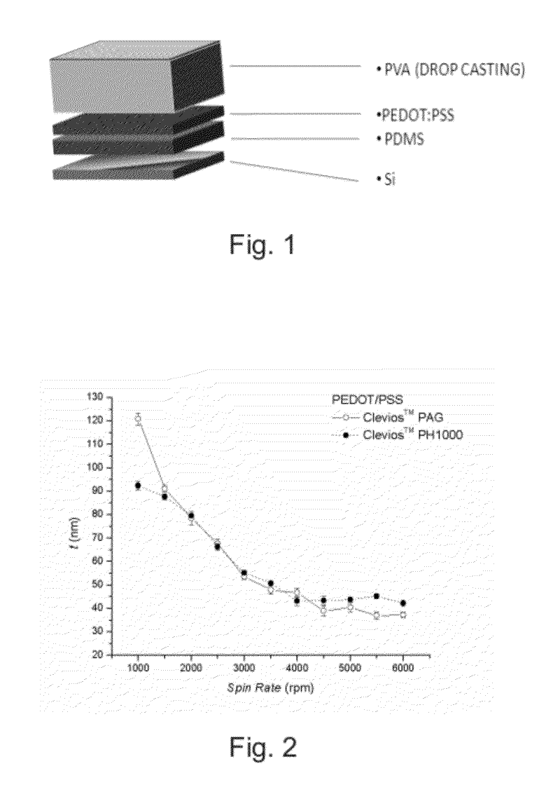

PAG@PDMS: nanofilms prepared from CLEVIOS™ PAG again supported on Si/PDMS (obtained from the depositing of a layer of a second polymer layer according some embodiments);

PH1000@PDMS: nanofilms prepared from CLEVIOS™ PH1000 again supported on Si/PDMS (obtained from the depositing of a layer of a second polymer layer according to some embodiments);

PH1000@Glass: free-standing nanofilms prepared from CLEVIOS™ PH1000 transferred on glass (obtained from the releasing of the layer of the conductive polymer according to some embodiments, then transferred on glass));

PH1000@Glass*: free-standing nanofilms prepared from CLEVIOS™ PH1000 transferred on glass and subjected to thermal treatment at the temperature of 170° C. for 1 hour (obtained from the releasing of the layer of the conductive polymer according to some embodiments, then transferred on glass and subjected to thermal treatment), then transferred on glass and subjected to thermal treatment).

### DETAILED DESCRIPTION

Provided herein are methods and systems for preparing nanofilms of conductive polymers. Conductive polymers comprise polymers known for their properties of stability and conductivity, which can make them potential replacements for inorganic conductive materials in electrical and electronic devices. For such applications, materials which are able to be obtained in the form of thin films can be selected in connection with some embodiments where thin films are desired. However conductive polymers, that have low solubility in common solvents, can be difficult to manipulate under certain condition in order to obtain thin conductive films and their dispersion and/or solubilisation can be difficult due in certain applications at least in part to the lack of adequate solubilisation media and techniques that are simple and cost-effective. In order to minimize this problem, these polymers are often prepared in situ directly on a desired substrate, from a respective monomer with chemical or electrochemical processes. In this case, however, the subsequent removal of the film, or transferral of the film onto other substrates, can be difficult, and for many applications it can be required to have films of conductive polymers without a support, so-called “free-standing” films.

One example of a conductive polymer is poly(3,4-ethylendioxytiophene), or PEDOT. Due at least in part to its conductivity and chemical stability, PEDOT is one of the most successful conductive polymers, particularly in the form of a complex with polystyrene sulphonate, or PSS(S. Kirchmeyer et al., J. of Materials Chemistry 2005, 15, 2077) an aqueous dispersion of which is commercially available and has been used for some time to produce conductive coatings on different substrates, as described, for example, in EP1616893. The above-mentioned forms of PEDOT can be used, for example, as a conductive coating in optoelectronic multi-layer structures, in an electrolytic condenser, or as an active material in transducers, for example, based on its properties of responsiveness to external physical stimuli. Biocompatibility of PEDOT has also been recently demonstrated and has led to its application for the development of microelectrodes for neural interface, for example, for building supports for adhesion and proliferation of epithelial cells which can be controlled by the electrochemical modulation of surface properties [M. H. Bolin et al., Sensors and Actuators, B: Chemical 2009, 142, 451; and K. Svennerstenet al., Biomaterials 2009, 30, 6257].

Conductive polymers can be prepared through methods to obtain films of substantial thickness, comprised between 5-10 μm and a few cm [see for example H. Okuzaki et al., J. Phys. Chem. B 2009, 113, 11378]. Such methods refer mainly to techniques of deposition of film by solvent casting, which can be intrinsically not very specific for obtaining films with nanometric thickness. Moreover, control of the thickness obtainable with such methods can be challenging and inaccurate; and, even when these methods are used with suitable modifications to obtain nanofilms, the release of the nanofilm from the substrate and transferral can be difficult due to nanofilm fragility.

Certain nanofilms of conductive polymers can be released in water, consisting of three alternate layers of graphene, PEDOT and graphene [see K. S. Choi et al. (Langmuir 2010, 26 (15), 12902-12908)]; but the process for its preparation can be long and complicated and can be wasteful both in terms of materials used and in terms of equipment. Moreover, the use of solvents and chemical reactants that can be considered non-biocompatible can have a negative impact upon the biocompatibility of the nanofilm thus obtained, although biocompatibility of these nanofilms was not specifically investigated.

Certain free-standing polysaccharide nanofilms, for biomedical applications can be prepared according to a process, consisting of a deposition by spin-coating directly on a support of SiO₂ of aqueous solutions of polysaccharides, such as chitosan and sodium alginate, followed by a deposition of a layer of polyvinyl alcohol (PVA) by “drop-casting” [Fujie et al. (Adv. Funct. Mater. 2009, 19, 2560-2568)]. A bi-layer film consisting of polysaccharide and PVA is then removed from the SiO₂ support with tweezers and dipped in water where the layer of PVA dissolves, releasing a polysaccharide nanofilm. In this process there is no mention of intermediate layers between support for growth of SiO₂ and the polysaccharide layer, nor is there reference to conductive polymers, and in general to the possibility of using a similar method to produce nanofilms of different polymers to the polysaccharide polymers given as an example.

A similar free-standing film was produced by a process where polyacrylic acid (PAA) is used as water-soluble sacrificial layer instead of polyvinyl alcohol (PVA), for deposition on a multi-layer film where many different polymers were cross-linked and in turn deposited on a printed support [Stroock et al., Langmuir, 2003, 19, 2466-2472]. The surface of the films obtained with this process was very small.

Therefore, having a simple and cost-effective process can be particularly challenging in particular when in connection to the production of biocompatible nanofilms of conductive polymers, which are free-standing, capable of supporting themselves and of keeping their characteristics of stability and conductivity even when released from the support on which they were prepared.

Methods and systems according to the present disclosure provide in some embodiments a simple and cost-effective process, suitable for a preparation of free-standing nanofilms of conductive polymers. A method according to the present disclosure for producing the free-standing nanofilms which, in some embodiments, does not compromise the biocompatibility of the polymer used, so that the films thus obtained can be highly biocompatible, and particularly in embodiments where PEDOT or a biocompatible form thereof is used. In these embodiments, the films can be suitable for biomedical applications, for example, for use as supports for seeding and proliferation of cells.

Therefore, embodiments of the present disclosure provide a process for a preparation of biocompatible, free-standing nanofilms of conductive polymers, comprising: a sequential deposition on a support for growth of a layer of a first polymer and of a layer of a conductive polymer, wherein the deposition of the layer of the conductive polymer is carried out by spin-coating, to obtain a film comprising the layer of the first polymer and the layer of conductive polymer on the support for growth; a thermal treatment of the film; a deposition of a layer of a second polymer, soluble in water such that the layer of the conductive polymer adheres to the layer of the second polymer; a peeling off of the layer of the conductive polymer on the layer of second polymer, from the layer of a first polymer on support for growth; a release of the layer of the conductive polymer as a free-standing nanofilm by immersion in water of the layer of the conductive polymer on the layer of the second polymer, and dissolving the layer of the second polymer.

Some embodiments of the disclosure provide a method to obtain films comprising a layer of a conductive polymer on a layer of the second polymer and a method for their use in the preparation of free-standing nanofilms of the disclosure by dissolving the layer of the second polymer.

Films obtained with the process according to the disclosure can have a high surface area/thickness ratio and, and even without a support, can remain flexible and strong, with high adhesiveness. The films can also be stable and relatively easy to manipulate in aqueous environments or in biological fluids, and thus can be suitable for a wide range of applications, for example, applications in the biomedical field. The films can also be characterised in some embodiments, as having a relatively high homogeneity and can be equipped with conductive properties, which can make them useful, for example, for the preparation of supports for cell cultures in which growth and cell proliferation can be stimulated by electrical impulses.

In some embodiments of the process according to the disclosure, a layer of a first polymer is deposited on a support adapted for growth of a plurality of polymer layers, herein also “support” or “support for growth”. The support, for example, can be selected among planar supports commonly used in preparations of supported films, including but not limited to supports made of silicon, silicon nitride, quartz, glass, indium oxide doped with tin (ITO), and ceramic materials.

In some embodiments, a deposition of a layer of conductive polymer can be carried out, for example, by “spin-coating”, a technique of deposition of polymeric films on supports that is well known in the field and described for example in D. Meyerhofer, Journal of Applied Physics 1978, 49, 3993-3997, herein incorporated by reference in its entirety. In some embodiments, the deposition of the layer of first polymer can also be carried out with spin-coating, however, other techniques known in the field, for example, spray-coating, inkjet printing, screen printing, and other techniques identifiable by a skilled person upon reading the present disclosure, could be used.

In some embodiments, for preparing an intermediate layer between the support for growth and the layer of the conductive polymer, a first polymer can be selected from a hydrophobic polymer that can be deposited on a support creating a planar thin layer, for example, by spin-coating of a precursor thereof, and a surface of which can be made hydrophilic by, for example, a plasma treatment. The first polymer in the present process can be selected, for example, among epoxy resins, such as the formulations used in UV photolithography processes which are commercially available under the name SU8 (Microchem, USA), and silicon polymers, for example, those that can be obtained using chlorosilanes as precursors, in particular methylchlorosilanes, ethylchlorosilanes, and phenylchlorosilanes. In some embodiments the silicon polymer that is used is poly(dimethyl siloxane) (PDMS). In these embodiments, PDMS can be prepared, for example, from a mixture containing prepolymer and cross-linking agent, and is commercially available under the trademark SYLGARD® (DOW® Corp, USA).

In some embodiments, when the deposition is carried out by spin-coating of PDMS or of another high-viscosity silicon polymer, a suitable solvent, can be mixed with the polymer or with a precursor thereof, in a quantity comprised, for example, between 5 and 140% by weight with respect to the weight of the mixture, which can lower the viscosity of the polymer or precursor thereof to obtain a low thickness of the layer for spin-coating. Suitable solvents can include but are not limited to n-alkanes, for example, n-hexane or n-heptane.

Moreover, in some embodiments, according to the material selected as the first polymer, a further treatment can be carried out before carrying out the deposition of the layer of conductive polymer, in order to increase a surface wettability of the layer of the first polymer. For example, when PDMS is selected as first polymer, a plasma treatment of O₂ can be carried out before proceeding to the deposition of the layer of conductive polymer.

The process of the disclosure can be carried out using a conductive polymer, mixtures of conductive polymers, or complexes of conductive polymers, which can be obtained in the form of a solution or an aqueous dispersion.

The term “conductive polymer” as used herein refers to an organic polymer which is capable of conducting electrical charges (e.g. ion and electronic), and can be generally defined as a polymer having electrical conductivity a comprised between 10⁻³ and 10⁵ S/cm. In some embodiments, the conductive polymers have an electrical conductivity comprised between 0.1 and 1000 S/cm, which can be maintained by a nanofilm obtained according to the process of the present disclosure. Conductive polymers can be selected, for example, among so-called “conjugated polymers” or “intrinsically conductive polymers” (ICP) or polymers consisting of molecules with conjugated bonds which can owe their conductivity to the particular structure. In some embodiments, the conductive polymer can be complexed with suitable dispersants to make them available in the form of an aqueous dispersion. Examples of such conductive polymers include but are not limited to polypyrrol, polythiophene, polyaniline, and derivatives thereof. In some embodiments, polythiophene and/or derivatives of polythiophene are used as the conductive polymer. Polythiophene and polythiophene derivatives can have characteristics of relatively high durability and conductivity compared to other conductive polymers.

Conjugated polymers according to the present disclosure can have one or more substituents which can be the same or different from any other substituent. The substituents can be selected, for example, from the group consisting of alkyl, alkylene, alkynyl, alkoxy, alkylthio and amino groups, but are not limited to these substituents. In embodiments where there are two substituents, bound together, they can form a ring adjacent to the thiophene ring, for example, two alkoxy groups can form a dioxane ring. In some embodiments, the conductive polymer is a derivative of polythiophene in which the two substituents form a dioxane ring, for example, poly(3,4-ethylendioxytiophene) commonly known by the acronym PEDOT, in the form of a complex with a dispersing agent, for example with polystyrene sulphonate (PSS). In some embodiments, conductive polymers are complexes commonly indicated by the acronym PEDOT/PSS, in which the weight ratio of the two components can be comprised between approximately 1/2.5 and 1/20, and it is for example equal to 1/2.5 like in the commercial products CLEVIOS™ PAG and CLEVIOS™ PH1000 (H. C. Starck GmbH, Leverkusen, Germany), respectively.

The film comprising the layer of the first polymer and the layer of the conductive polymer deposited on the support adapted for growth of a plurality of polymer layers, can then subjected to a thermal treatment. The thermal treatment can be carried out, for example, at a temperature comprised between 90 and 200° C. In some embodiments, the film is subjected to a temperature of approximately 170° C. for approximately 1 hour.

According to some embodiments, polymers suitable for the preparation of the layer of the second polymer comprise water-soluble polymers, for example. The water-soluble polymers can be selected from the group consisting of polyvinyl alcohol (PVA), polyvinylpyrrolidone (PVP), polyethylene glycol (PEG), and water-soluble cellulose ethers, however are not limited to these examples. In some embodiments the layer of the second polymer is a layer of PVA, prepared by drop-casting deposition of an aqueous solution of PVA, having a concentration, for example, comprised between 5 and 20% by weight of PVA with respect of a total weight of a solution.

The term “water-soluble polymer” as used herein refers to a polymer that can be dissolved in water as defined, for example, by Graham S. et al. in Requirements for biodegradable water-soluble polymers, Polymer Degradation and Stability, 1998, 59, 19-24, herein incorporated by reference in its entirety. For example, polymers that can have solubility in water up to values of approximately 10-20% by weight at room temperature can be considered to be “water-soluble”; when deposited in layers of typical thickness such as those described here, these “water-soluble” polymers can be completely dissolved in water, without leaving any substantial residue and without the use of agitation, in a short time period (for example between 60 and 600 seconds) and at a temperature of approximately 25° C.

In some embodiments of the present disclosure, deposition of the layer of the second polymer can be carried out with a technique selected among those known and commonly used in the field of production of polymeric films, with which the layer of conductive polymer adheres preferentially to the layer of first polymer, then in the next step, the layer of conductive polymer adhered on the layer of second polymer can be peeled off from the layer of first polymer on the support for growth. Such a peeling off operation can be performed, for example, by cutting the surface with a thin blade and/or by lifting the film, for example, with tweezers.

In embodiments of the present disclosure, the release of the nanofilm of conductive polymer can be carried out, for example, by dissolving the support layer in water. In some embodiments, using mechanical stifling and/or using water at a temperature of between approximately 35 and 40° C. during the dissolving of the support layer can facilitate and/or speed up the release of the nanofilm in water.

In some embodiments, transferral of the nanofilm in other aqueous solutions or biological fluids can be carried out, for example, by suction and expulsion with a pipette, while substantially avoiding any damage to the nanofilm. Therefore, the nanofilms obtained with the process according to the present disclosure can therefore be re-deposited on solid substrates of various kinds and geometries according to a particular application, for example, on substrates made from glass, paper, steel, metals, plastic, elastomers, samples of human skin, and can display adhesion to the substrate, due at least in part to the flexibility and the nanometric thickness of the film which can allow it to adapt to the micro-corrugations and porosities present on a surface of the materials. The deposition of the nanofilm on the substrates can be carried out, for example, directly or by means of perforated meshes of metal wire, preventing the film from drying out completely before it is deposited on the substrate. At this point is it possible to proceed to drying, for example, with a jet of compressed air and/or thermal treatments, to eliminate any residual water from the surface and to improve adhesion to the substrate. Once deposited on the substrate, the film can also be cut, for example, with a suitable metallic blade.

Embodiments of the present disclosure can thus provide a method to obtain strong polymeric films, which can be equipped with limited degradability over time, homogeneity and conductive properties, and which have dimensions with thickness typically comprised between 40 and 200 nm, and in some embodiments, comprised between 45 and 100 nm, and a large surface, for example, greater than approximately 1 cm². Within these ranges the thickness of the polymeric films according to the present disclosure can be varied according to a desired application, for example, by varying parameters of the process, for example, speed and rotation times of the spin-coating steps, types of polymers used, or other parameters identifiable by a skilled person.

Nanofilms according to the present disclosure can have chemical and structural stability and resistance when released in a form of self-supporting films in water, aqueous solutions or biological fluids, and in particular, the release from the support and transferral in water does not substantially compromise the stability and integrity even of polymeric films with a surface of several cm².

Characteristics of the nanofilms according to the present disclosure can have applications, for example, in the field of development of sensors and actuators, such as “smart material”, in movement in water or other biological fluids of objects in the micro- and meso-scale, in the manufacture of multi-layer and/or multifunctional structures, in the deposition of nanometric conductive films on microfabricated artefacts, and/or on biological samples or other objects including those characterised by non-planar and/or complicated geometries.

Nanofilms according to the present disclosure can be biocompatible.

The term “biocompatible” as used herein refers to products that, when placed in direct contact with organisms, such as, for example, cells, microorganisms, and/or tissues, substantially avoid harmful effects on vital functions of the organism and/or are effectively metabolised by the organism. In particular, nanofilms of the present disclosure can have biocompatibility in vitro with respect to maintaining cell vitality through adhesion tests and vitality of cell cultures with cells of various kinds, in the short, medium and/or long term. In some embodiments, the materials used to make the presently described nanofilms have also been shown to be biocompatible in vivo in tests on animals, and in the application to construction and coating of neural electrodes, where it has been shown that there can be an absence of harmful effects even in the long term.

Nanofilms of the present disclosure can be used, for example, as substrates for adhesion, growth, differentiation and/or electrical and mechanical stimulation of cells, also in order to develop bio-hybrid devices and actuators. In such micro-devices use of cell lines capable of contracting spontaneously (for example cardiomyocites) or when subjected to electrical stimuli (for example myoblasts) as active elements for actuation, can be combined with micro-electronic systems, as described for example in A. W. Feinberg et al., Science 2007, 317, 1366.

The nanofilms according to the present disclosure can be particularly suitable as a support for adhesion of cells and making such devices, since they can be manipulated in an aqueous environment, can have nanometric thickness, and can have controllable flexibility and high modulus of elasticity. The possibility of electrical conduction can also allow a direct and controlled stimulation of muscle cells, which can make the nanofilms of the disclosure suitable as components for making muscles in vitro and/or for the development of new bio-hybrid devices.

Other biomedical applications of nanofilms herein described comprise applications, for example, in the field of regenerative medicine, in tissue engineering, and in development of devices for the controlled release of drugs.

Further applications of the nanofilms herein described are identifiable by a skilled person upon reading the present disclosure.

### EXAMPLES

The following examples are disclosed for further illustration of the embodiments and are not intended to be limiting in any way.

### Example 1

On a silicon substrate of dimensions 30×30 mm, 1.5 ml of a product prepared by mixing 12 mg of silicon prepolymer (component A) and 1.2 mg of cross-linking agent (component B) of the commercial bi-component product SYLGARD® 184 (DOW® Corp., USA) and n-hexane in a quantity equal to 10% by weight with respect to the total weight of the mixture, were deposited. Before deposition on the substrate, the mixture was vigorously mixed for a few minutes and then subjected to a vacuum degassing treatment for a few minutes, to eliminate the air bubbles that form during the mixing of the components.

The substrate was then made to rotate at a rotation speed of 6000 rpm for 150 seconds, then placed in an oven at a temperature of 95° C. for 1 hour for the cross-linking and formation of the layer of PDMS. The surface of PDMS thus obtained was then subjected to treatment with air plasma at a pressure of 250 mTorr with a power of 6.8 W for 1 minute and 20 seconds, with the help of the Plasma Cleaner PDC-32G apparatus, produced by Hayrick Plasma Inc.

On the layer of PDMS thus obtained a layer of PEDOT/PSS was then deposited, again by spin-coating, using the commercial product CLEVIOS™ PAG (H. C. Starck GmbH, Germany), consisting of an aqueous dispersion of PEDOT/PSS in which the weight ratio PEDOT/PSS is 1/2.5; the substrate was set in rotation for 1 minute at a speed of 1000 rpm, with an acceleration of 500 rpm/s.

On the product thus obtained, after having been subjected to thermal treatment for 1 hour at a temperature of 170° C., the deposition was carried out, by drop casting, of an aqueous solution of PVA of concentration equal to 10% by weight with respect of the total weight of the solution. After air drying, at room temperature, for about 8 hours, the surface of PVA was cut with a suitable thin blade and the film was peeled off the substrate for growth, lifting it with the help of tweezers. The layer of PVA was peeled off going behind the conductive layer of PEDOT/PSS, thanks to the greater adhesion of the latter to PVA with respect to PDMS. The film of PVA and PEDOT/PSS was then placed in water where the layer of PVA completely dissolved, releasing the desired free-standing film of PEDOT/PSS in water.

In order to evaluate the thickness of the film obtained, it was deposited on the surface of a Silicon substrate and dried there with the help of a flow of nitrogen. The thickness of the film obtained was measured with an atomic force microscope (AFM), found to be equal to 121 nm.

### Example 2

The preparation described in Example 1 was repeated in an analogous manner to Example 1 above but using, instead of CLEVIOS™ PAG, the commercial product CLEVIOS™ PH1000, again consisting of an aqueous dispersion of PEDOT/PSS, having a weight ratio PEDOT/PSS equal to 1/2.5.

At the end of preparation the thickness of the film was measured as described above in Example 1, found to be equal to 92 nm.

### Example 3

The preparations described above in Example 1 and in Example 2 have been repeated in an analogous manner to Example 1 and Example 2 above, varying he rotation speed of the step of deposition of the layer of PEDOT/PSS, and using the following speed values: 1500 rpm, 2000 rpm, 2500 rpm, 3000 rpm, 3500 rpm, 4000 rpm, 4500 rpm, 5000 rpm, 5500 rpm, and 6000 rpm. At the end of each experiment the thickness of the film obtained was measured, as described above in Example 1. The following Table 1 gives the values obtained, whereas FIG. 2 illustrates the progression thereof as the rotation speed varies:

TABLE 1

| rotation | film thickness (nm) | |
|---|---|---|
| speed | CLEVIOS ™ | CLEVIOS ™ |
| (rpm) | PAG | PH1000 |
| 1000 | 120.9 | 92.4 |
| 1500 | 91.1 | 87.6 |
| 2000 | 78.6 | 79.6 |
| 2500 | 67.6 | 66.2 |
| 3000 | 53.6 | 55.3 |
| 3500 | 47.9 | 50.8 |
| 4000 | 46.7 | 43.2 |
| 4500 | 38.9 | 43.4 |
| 5000 | 40.5 | 43.8 |
| 5500 | 37.0 | 45.3 |
| 6000 | 37.3 | 42.2 |

### Example 4

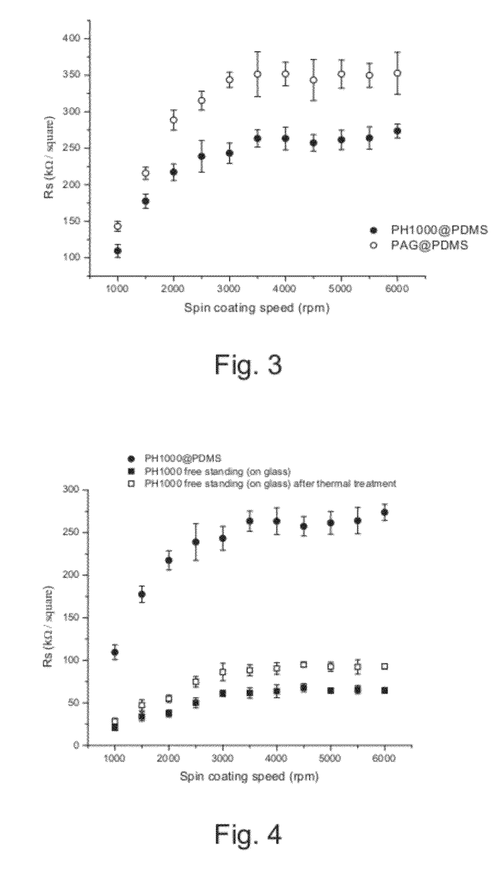

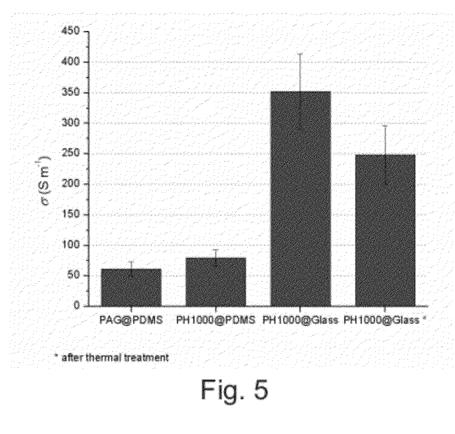

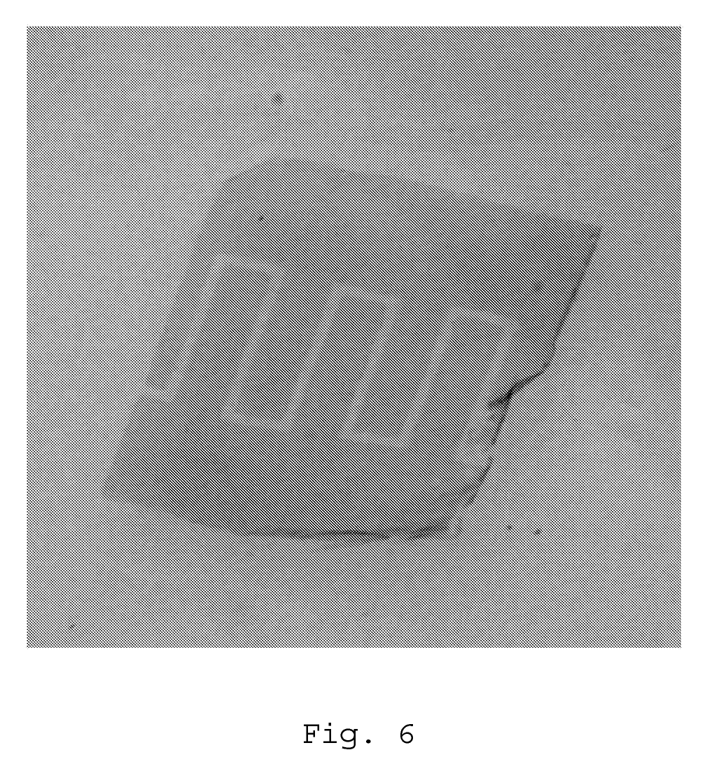

The films of PEDOT/PSS again supported on Si/PDMS obtained as described in Examples 1-3, before the deposition of the layer of PVA, were subjected to measurement of the surface resistance with a four-point method, using a 4-Point Probe Head (Jandel Engineering Ltd., GB). The fall in voltage at the two internal pins of the measurement head in contact with the sample was measured through a multimeter in conditions of application of a current equal to 1 mA through the external pins with the help of a potentiostat (mod. 7050, Amel Instruments, IT). FIG. 3 shows the progression of the surface resistance values detected as a function of the rotation speed, and for both of the two series of films obtained using the two different commercial precursors of the layer of PEDOT/PSS.

### Example 5

The films of PEDOT/PSS, released in water and obtained as described in Examples 1-3 given above, were transferred onto glass supports and subjected to thermal treatment for 1 hour at a temperature of 170° C. until elimination of the residual water.

The films thus obtained were subjected to measurement of the surface resistance with the same method and in the same conditions described above in Example 4. FIG. 4 shows the progression of the values of surface resistance detected for two series of films of PEDOT/PSS prepared from CLEVIOS™ PH1000 and transferred on glass and, for comparison, the progression of the values detected for the films supported on Si/PDMS prepared from CLEVIOS™ PH1000 and already given in FIG. 3.

### Example 6

Two samples of the nanofilm prepared as described above in Example 2, using the commercial product CLEVIOS™ PH1000 in the step of deposition of the layer of PEDOT/PSS, with a rotation speed of 1500 rpm, were subjected to an O₂ plasma treatment for a time equal to 45 seconds, followed by the formation of a fibronectin coating. On the samples thus treated two types of cells were seeded, muscle skeletal cells C2C12 and cardiac cells H9c2, so as to obtain a concentration equal to 25,000 cells/cm².

The biocompatibility and the cellular adhesion were verified with a test that makes it possible to evaluate the cell vitality measured through LIVE/DEAD® fluorescent colouring, in which particular dyes are used to distinguish, in fluorescent microscope images, the live cells—green in colour—from dead ones—red in colour. The evaluation of the cellular material with this method was carried out 24 hours after seeding, and 7 days after seeding, for both types of cells, in both cases verifying the excellent biocompatibility of the nanofilm of the disclosure coated with fibronectin, and the high adhesion of the cells both in the short and in the long term.

### Example 7

On a sample of the nanofilm prepared as described above in Example 2, using the commercial product CLEVIOS™ PH1000 in the step of deposition of the layer of PEDOT/PSS, with a rotation speed of 1500 rpm, without the fibronectin coating and in the absence of any treatment suitable for modifying its surface properties, muscle skeletal cells C2C12 were seeded at a concentration equal to 10.000 cells/cm² and the test with LIVE/DEAD® fluorescent colouring was carried out 24 hours after seeding. Also in this case it was found that almost all of the cells seeded on the nanofilm of the disclosure adhered and was live, demonstrating the biocompatibility of this material.

1.-24. (canceled)

25. A method for preparing biocompatible, free-standing nanofilms of conductive polymers, the method comprising:
sequentially depositing a layer of a first polymer and a layer of a conductive polymer on a support adapted for growth of a plurality of polymer layers, wherein the depositing of the layer of the conductive polymer comprises performing a spin-coating, to obtain a film comprising the layer of the first polymer and the layer of the conductive polymer on the support;
thermally treating the film;
depositing on the conductive polymer of the thermally treated film a layer of a second polymer such that the layer of the conductive polymer adheres to the layer of a second polymer, the layer of the second polymer being soluble in water;
peeling off the layer of the conductive polymer together with the layer of the second polymer, from the layer of the first polymer on the support to obtain a peeled off layer of the conductive polymer on the layer of the second polymer; and
releasing the layer of the conductive polymer as a free-standing nanofilm, the releasing comprising immersing the peeled off layer of the conductive polymer on the layer of a second polymer and dissolving the layer of the second polymer in water.

26. The method according to claim 25, wherein the conductive polymer is poly(3,4-ethylendioxytiophene) (PEDOT) in the form of a complex with a dispersing agent.

27. The method according to claim 26, wherein the dispersing agent is polystyrene sulphonate (PSS).

28. The method according to claim 27, wherein the weight ratio PEDOT/PSS is 1/2.5.

29. The method according to claim 25, wherein:
the first polymer is selected from the group consisting of a silicon polymer and a hydrophobic epoxy resin, and
after the depositing of the layer of the first polymer on the support, subjecting the layer of the first polymer to a plasma treatment before the depositing of the layer of the conductive polymer.

30. The method according to claim 25, wherein the layer of the first polymer is a layer of poly(dimethyl siloxane) (PDMS).

31. The method according to claim 30, wherein the depositing of the layer of poly(dimethyl siloxane) (PDMS) comprises spin-coating a precursor of poly(dimethyl siloxane) mixed with a solvent that lowers the viscosity of the precursor of poly(dimethyl siloxane).

32. The method according to claim 31 wherein the solvent is n-hexane in a quantity between 5 and 140% by weight with respect to the weight of the mixture.

33. The method according to claim 25, wherein the thermal treatment is carried out at a temperature ranging between 90 and 200° C.

34. The method according to claim 25, wherein the thermal treatment is carried out at temperature of approximately 170° C. for approximately 1 hour.

35. The method according to claim 25, wherein the second polymer is selected from the group consisting of polyvinyl alcohol (PVA), polyvinylpyrrolidone (PVP), polyethylene glycol (PEG), and water-soluble cellulose ethers.

36. The method according to claim 35, wherein the second polymer is polyvinyl alcohol (PVA).

37. The method according to claim 25, wherein:
the layer of second polymer is a layer of polyvinyl alcohol (PVA), and
the depositing of the layer comprises drop-casting an aqueous solution of PVA, the aqueous solution of PVE having concentration ranging between 5 and 20% by weight of PVA with respect of the total weight of the aqueous solution.

38. The method according to claim 25, wherein the release of the nanofilm is carried out using water at a temperature ranging between approximately 35 and 40° C. and/or under mechanical stirring.

39. The method according to claim 25, further comprising recovering the free-standing nanofilm from the aqueous solution.

40. The method according to claim 25, wherein the free-standing nanofilm has a thickness ranging between 40 and 200 nm.

41. The method according to claim 40, wherein the thickness of the nanofilm ranges between 45 and 100 nm.

42. An intermediate for a preparation of biocompatible, free-standing nanofilms of a conductive polymer, the intermediate comprising a layer of a conductive polymer on a layer of a second polymer, the intermediate obtainable by a method comprising:
sequentially depositing a layer of a first polymer and a layer of a conductive polymer on a support adapted for growth of a plurality of polymer layers, wherein the depositing of the layer of the conductive polymer comprises performing a spin-coating, to obtain a film comprising the layer of the first polymer and the layer of the conductive polymer on the support;
thermally treating the film;
depositing on the conductive polymer of the thermally treated film a layer of a second polymer such that the layer of the conductive polymer adheres to the layer of a second polymer, the layer of the second polymer being soluble in water; and
peeling off the layer of the conductive polymer together with the layer of the second polymer, from the layer of the first polymer on the support to obtain a peeled off layer of the conductive polymer on the layer of the second polymer.

43. A method for preparing biocompatible, free-standing nanofilms of conductive polymers, the method comprising preparing the intermediate according to claim 42, and dissolving the layer of the second polymer in water.

44. The method according to claim 39, wherein the recovering of the free-standing nanofilm comprises transferring the free-standing nanofilm in liquid media or on a solid support.
